(19) United States
(12) Patent Application Publication
(10) Pub. No.: US 2026/0236163 A1
(43) Pub. Date: Aug. 13, 2026

(54) PHYSICAL INPUT DEVICE EXTRACTION AND 3D RECONSTRUCTION

(71) Applicant: Samsung Electronics Co., Ltd., Suwon-si (KR)

(72) Inventor: Yingen Xiong, Mountain View, CA (US)

(21) Appl. No.: 19/272,959

(22) Filed: Jul. 17, 2025

Related U.S. Application Data
(60) Provisional application No. 63/757,220, filed on Feb. 11, 2025.

(51) Int. Cl. G06F 3/04886; G06F 3/04815; G06T 17/20; G06T 19/00; G06V 10/26; G06V 10/44; G06V 20/20

(52) U.S. Cl. CPC G06F 3/04886; G06F 3/04815; G06T 17/20; G06T 19/006; G06V 10/26; G06V 10/44; G06V 20/20; G06T 2200/24

(57) ABSTRACT

A method includes obtaining, using a plurality of sensors of an electronic device, one or more image frames of a scene and data associated with the image frames, where the data includes depth data. The method also includes identifying, using at least one processing device of the electronic device, a physical input device captured within the image frames. The method further includes generating, using the at least one processing device, a 3D virtual image of the physical input device. In addition, the method includes matching, using the at least one processing device, the 3D virtual image and a passthrough-transformed image of the physical input device to generate a final image frame for rendering.

### CROSS-REFERENCE TO RELATED APPLICATION AND PRIORITY CLAIM

This application claims priority under 35 U.S.C. § 119(e) to U.S. Provisional Patent Application No. 63/757,220 filed on Feb. 11, 2025, which is hereby incorporated by reference in its entirety.

### TECHNICAL FIELD

This disclosure relates generally to image processing systems and processes. More specifically, this disclosure relates to physical input device extraction and three-dimensional (3D) reconstruction.

### BACKGROUND

Extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

### SUMMARY

This disclosure relates to physical input device extraction and three-dimensional (3D) reconstruction.

In a first embodiment, a method includes obtaining, using a plurality of sensors of an electronic device, one or more image frames of a scene and data associated with the image frames, where the data includes depth data. The method also includes identifying, using at least one processing device of the electronic device, a physical input device captured within the image frames. The method further includes generating, using the at least one processing device, a 3D virtual image of the physical input device. In addition, the method includes matching, using the at least one processing device, the 3D virtual image and a passthrough-transformed image of the physical input device to generate a final image frame for rendering.

In a second embodiment, an electronic device includes a plurality of sensors configured to obtain one or more image frames of a scene and data associated with the image frames, where the data includes depth data. The electronic device also includes at least one processing device configured to identify a physical input device captured within the image frames. The at least one processing device is also configured to generate a 3D virtual image of the physical input device. The at least one processing device is further configured to match the 3D virtual image and a passthrough-transformed image of the physical input device to generate a final image frame for rendering.

In a third embodiment, a non-transitory machine readable medium contains instructions that when executed cause at least one processor of an electronic device to obtain one or more image frames of a scene and data associated with the image frames, where the data includes depth data. The non-transitory machine readable medium also contains instructions that when executed cause the at least one processor to identify a physical input device captured within the image frames. The non-transitory machine readable medium further contains instructions that when executed cause the at least one processor to generate a 3D virtual image of the physical input device. In addition, the non-transitory machine readable medium contains instructions that when executed cause the at least one processor to match the 3D virtual image and a passthrough-transformed image of the physical input device to generate a final image frame for rendering.

Any one or any combination of the following features may be used with the first, second, or third embodiment.

The physical input device may be identified by performing passthrough transformations on the image frames to generate one or more transformed image frames; segmenting an input device region within the one or more transformed image frames to generate a segmented input device region; identifying keypoints in the segmented input device region using the depth data (where the keypoints may include corners, edges, patterns, and input device components); identifying an input device type using the keypoints and/or an input device model library including different types of physical input devices and corresponding 3D reconstructed input device models; refining the input device region using the keypoints and the input device type to generate a refined input device region; and extracting the refined input device region from the one or more transformed image frames to generate an extracted input device region.

The 3D virtual image may be generated by creating a 3D input device mask using a dense depth map of the extracted input device region; performing 3D reconstruction on the 3D input device mask using the keypoints and a boundary of the extracted input device region to generate a 3D reconstructed input device model; and generating one or more virtual views of the 3D reconstructed input device model.

The 3D input device mask may be generated by creating a two-dimensional (2D) input device mask using the extracted input device region and a boundary of the extracted input device region and creating the 3D input device mask with the 2D input device mask and the dense depth map.

The 3D input device mask may be generated by creating an input device component layout on the 3D input device mask.

The 3D reconstruction may be performed by generating an input device contour and boundary using the 3D input device mask; generating input device component blocks and an input device component layout using the 3D input device mask and the dense depth map; generating a 3D mesh of the physical input device using the input device contour and boundary and the input device component blocks; and generating the 3D reconstructed input device model using the input device component layout and the 3D mesh.

The 3D virtual image and the passthrough-transformed image of the physical input device may be matched by overlapping the 3D virtual image with the passthrough-transformed image of the physical input device and connecting input device components and a finger gesture sensor of the plurality of the sensors to detect and recognize a finger gesture and a corresponding user input. The finger gesture sensor may apply an occlusion culling.

An input device model library may be created. The input device model library may include different types of physical input devices and information associated with each type. The information associated with each type may include an input device component layout, an input device size, an input device region, an input device boundary, input device specifications, and a corresponding 3D reconstructed input device model. The input device model library may be updated with one or more new types of physical input devices upon detection, information associated with the one or more new types, and one or more corresponding 3D reconstructed input device models.

The plurality of sensors may track finger gestures made on the physical input device, detect the finger gestures to recognize a user input, and provide the user input to the electronic device for execution of the user input.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIG. 2 illustrates an example process for physical input device extraction and three-dimensional (3D) reconstruction in accordance with this disclosure;

FIG. 3 illustrates another example process for physical keyboard extraction and 3D reconstruction in accordance with this disclosure;

FIG. 4 illustrates an example technique for online creation of a 3D-reconstructed keyboard using a keyboard model library in accordance with this disclosure;

FIG. 5 illustrates an example pipeline for offline creation of a 3D-reconstructed keyboard using a keyboard model library in accordance with this disclosure;

FIG. 6 illustrates an example technique for 3D mask generation of a keyboard in accordance with this disclosure;

FIG. 7 illustrates an example technique for 3D keyboard reconstruction in accordance with this disclosure;

FIG. 8 illustrates an example technique for matching virtual and physical images of a keyboard in accordance with this disclosure;

FIG. 9 illustrates an example diagram of 3D keyboard reconstruction in accordance with this disclosure;

FIG. 10 illustrates an example technique for keyboard tracking and extraction in accordance with this disclosure;

FIG. 11 illustrates example coordinate systems for keyboard tracking and 3D reconstruction in accordance with this disclosure;

FIG. 12 illustrates an example technique for keyboard feature detection in accordance with this disclosure;

FIG. 13 illustrates an example process for keyboard detection in accordance with this disclosure;

FIG. 14 illustrates an example process for matching a virtual and physical keyboards based on 3D keyboard reconstruction in accordance with this disclosure; and

FIG. 15 illustrates an example method for physical input device extraction and 3D reconstruction in accordance with this disclosure.

### DETAILED DESCRIPTION

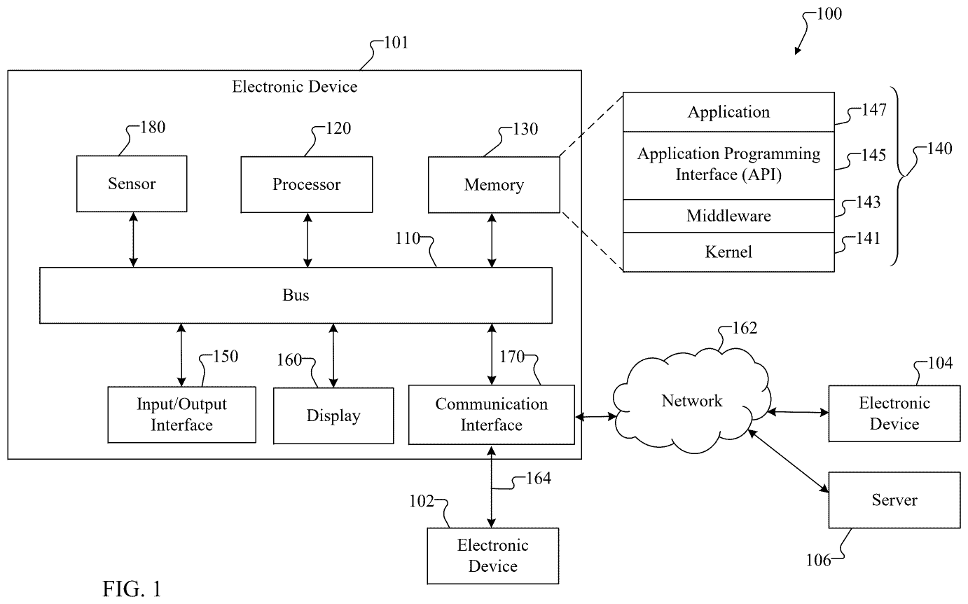

FIGS. 1 through 15, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

Optical see-through (OST) XR systems refer to XR systems in which users directly view real-world scenes through head-mounted devices (HMDs). Unfortunately, OST XR systems face many challenges that can limit their adoption. Some of these challenges include limited fields of view, limited usage spaces (such as indoor-only usage), failure to display fully-opaque black objects, and usage of complicated optical pipelines that may require projectors, waveguides, and other optical elements. In contrast to OST XR systems, video see-through (VST) XR systems (also called “passthrough” XR systems) present users with generated video sequences of real-world scenes. VST XR systems can be built using virtual reality (VR) technologies and can have various advantages over OST XR systems. For example, VST XR systems can provide wider fields of view and can provide improved contextual augmented reality.

A VST XR device often includes one or more imaging sensors (also called “see-through cameras”) that capture high-resolution image frames of a user's surrounding environment. These image frames are processed in an image processing pipeline in order to generate final rendered views of the user's surrounding environment. In addition to generating views of a scene, these image frames can also provide an alternative mechanism for information input and control. For example, when using a computer, a user can provide input via one or more input devices, such as a keyboard, mouse, electronic pen, joystick, toy gun, or car wheel. An input device can be used to enter text as well as commands. However, a VST XR device may not be physically connected to an input device for various reasons. For example, a VST XR device may not be connected to a physical keyboard since (i) it may not be convenient to physically connect the keyboard to the VST XR device and (ii) such a physical connection may require use of already-limited resources of the VST XR device.

In some instances, virtual keyboards have been used to save resources. However, a virtual keyboard typically needs to be rendered for display on a screen of a VST XR device so as to mix virtual keyboard images with a captured scene. Such mixing, however, can result in breaking of the view of the captured scene, thereby causing user dissatisfaction. Moreover, a user cannot have the real experience of using a keyboard since he or she cannot touch the physical keyboard and/or hear the sounds of finger strokes on keys as the user is accustomed to when using a real keyboard. Such disconnect from real life experience can decrease user experience and enjoyment.

This disclosure provides various techniques supporting physical input device extraction and 3D reconstruction for XR or other applications. As described in more detail below, one or more image frames of a scene and data associated with the image frames can be obtained, and the data can include depth data. A physical input device captured within the image frames can be identified, and a 3D virtual image of the physical input device can be generated. The 3D virtual image and a passthrough-transformed image of the physical input device can be matched to generate a final image frame for rendering.

In this way, it is possible for a 3D-reconstructed input device to be overlapped and matched with a real-world input device. Hence, when a user uses the real-world input device, for example, the user's finger gestures can be captured using a finger tracking device and sent to an XR device or other system as device inputs. As a result, the disclosed techniques can allow the user to use any suitable type of input device without physically connecting the input device to an XR device or other system. Moreover, since the physical input device extraction and 3D reconstruction can be performed on various types or models of input devices on-the-fly, the user may not need to enter information defining the input device beforehand and may simply be able to start using the input device.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to physical input device extraction and 3D reconstruction in XR or other applications.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform physical input device extraction and 3D reconstruction in XR or other applications. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include one or more cameras or other imaging sensors, which may be used to capture image frames of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to physical input device extraction and 3D reconstruction in XR or other applications.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

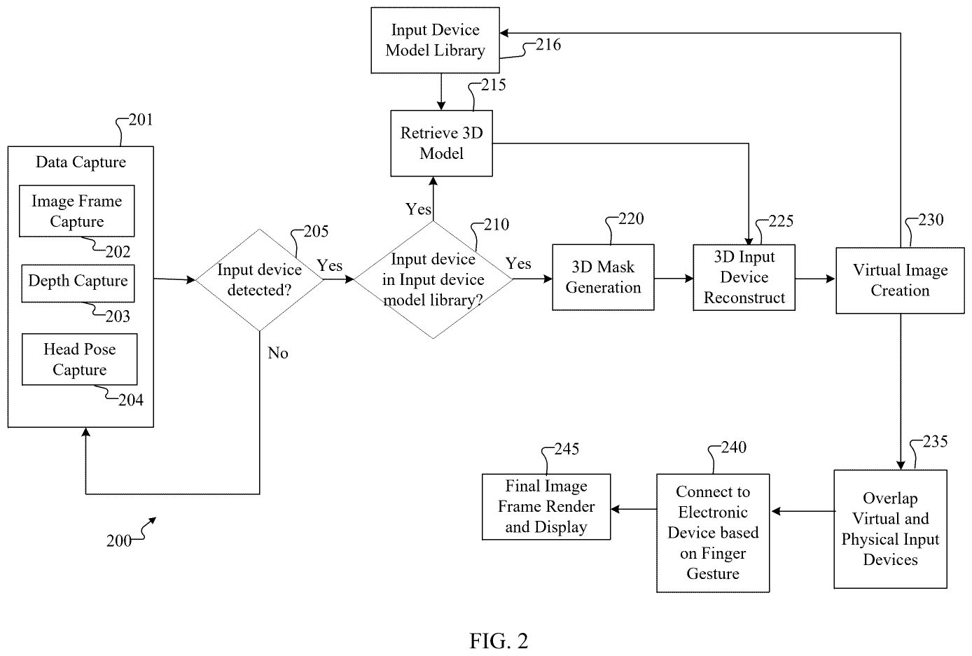

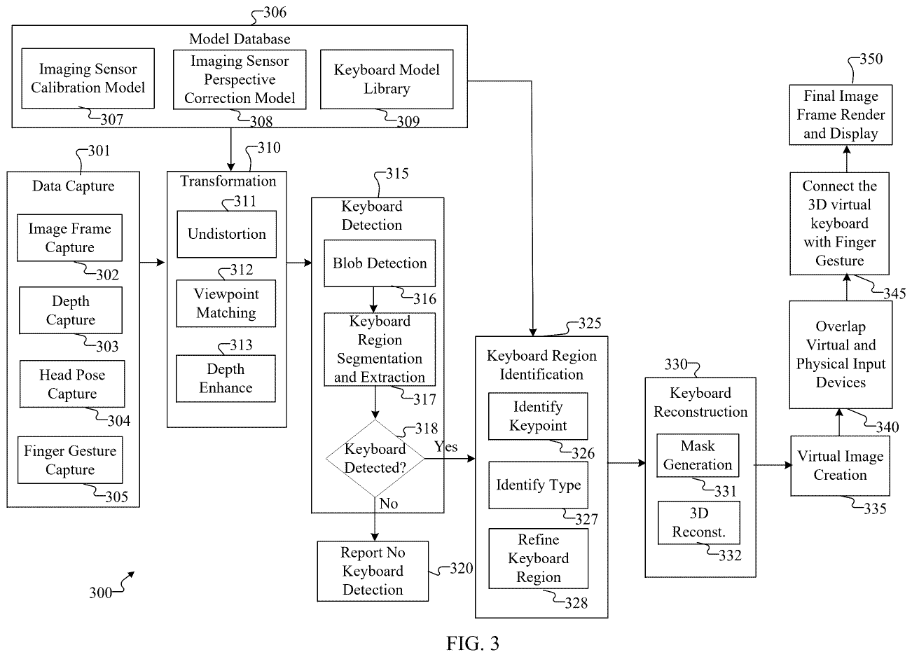

FIG. 2 illustrates an example process 200 for physical input device extraction and 3D reconstruction in accordance with this disclosure. For ease of explanation, the process 200 shown in FIG. 2 is described as being performed using the electronic device 101 in the network configuration 100 shown in FIG. 1. However, the process 200 shown in FIG. 2 may be performed using any other suitable device(s) and in any other suitable system(s). Moreover, the process 200 is described in general to cover any physical input device extract and 3D reconstruction thereof. A detailed description of the physical input device extraction and 3D reconstruction process is provided for a specific example of a keyboard with reference to FIG. 3.

As shown in FIG. 2, the process 200 includes a data capture operation 201, a detection determination operation 205, a library determination operation 210, a retrieval operation 215, a 3D mask generation operation 220, a 3D reconstruction operation 225, a virtual image creation operation 230, a matching operation 235, a connection operation 240 and a final image frame rendering operation 245. The data capture operation 201 generally operates to capture one or more image frames and associated data. In this example, the data capture operation 201 includes an image frame capture operation 202, a depth capture operation 203, and a head pose capture operation 204. In some embodiments, it may also include a finger gesture capture operation as described in FIG. 3.

The image frame capture operation 202 generally operates to capture one or more image frames of a scene. This may include the processor 120 obtaining one or more image frames capturing the scene using one or more imaging sensors 180 of the electronic device 101, such as one or more forward-facing cameras or other imaging sensor(s) 180 of the electronic device 101. In some cases, each image frame may be a high-resolution color image frame. The one or more captured image frames can undergo one or more passthrough transformations. This may include the processor 120 applying one or more transformations to compensate for things like registration and parallax errors, which may be caused by factors like differences between the positions of the imaging sensor(s) 180 and a user's eyes.

The depth capture operation 203 generally operates to obtain depth data associated with each image frame. The depth data may be obtained from any suitable source(s), such as from one or more depth sensors like at least one time-of-flight (ToF) sensor, light detection and ranging (LiDAR) sensor, or stereo vision sensor. In some cases, for example, the depth data may include time measurements of light pulses returning to a ToF sensor, distorted light patterns, or RGB images from slightly different angles. The depth data obtained from the one or more depth sensors may often include low-resolution depth maps.

The head pose capture operation 204 generally operates to obtain information related to the pose of a user's head while the electronic device 101 is being used. The head pose information may be obtained from any suitable source(s), such as from one or more positional sensors like at least one IMU, head pose tracking camera, or other position sensor(s) 180 of the electronic device 101. In some cases, a localization and mapping algorithm may use the one or more images and the IMU data to obtain the head pose information expressed using six degrees of freedom, such as three translation values and three rotation values. The three translation values may identify the movement of the user's head along three orthogonal axes, and the three rotation values may identify rotation of the user's head about the three orthogonal axes. Note, however, that the head pose information may have any other suitable form.

The detection determination operation 205 generally operates to determine whether a physical input device is detected in the one or more images capturing the scene. This may include the processor 120 obtaining the one or more (passthrough) transformed image frames and detecting a physical input device within the one or more transformed image frames. This may also include the processor 120 performing depth-based input device detection. If a physical input device is detected, the processor 120 may extract the detected input device from the one or more transformed image frames, such as by using one or more warped depth maps. This may also include the processor 120 identifying device information, such as the type of the detected physical input device (like, in case of a keyboard, whether a MAC or WINDOWS keyboard is detected). If no physical input device is detected, the process 200 returns to the data capture operation 201.

The library determination operation 210 generally operates to determine whether an input device model library 216 includes the device information and 3D reconstructed model (a reference model) of a detected input device. If the input device model library 216 does not include the device information of the detected physical input device, the process 200 proceeds to the 3D reconstruction operation 225.

The retrieval operation 215 generally operates to retrieve the device information from the input device model library 216 based on a determination that the device information of the detected input device is included in the input device model library 216. This may include the processor 120 searching through an index, a type list, a label list, and the like in the input device model library 216 to obtain the relevant device information, such as the reference model of the detected input device.

The 3D mask generation operation 220 generally operates to create a 3D mask using the identified input device information. For example, if the device information of the detected input device is not included in the input device model library 216, the processor 120 may map the pixels of the detected input device region in one or more images to a 3D point cloud using a high-resolution depth map. This may also include the processor 120 refining the 3D point cloud by removing outliers (such as by using statistical filtering), clustering 3D points to isolate the input device, applying a 3D bounding box, and using depth-based keypoints to guide the refinement of the 3D cloud. This may further include the processor 120 converting the refined 3D cloud to a voxel grid or preliminary mesh for one or more objects. Thus, the 3D mask of the input device may represent a refined 3D point cloud, voxel grid, or mesh, effectively isolating the 3D input device region from the captured scene. In some embodiments, even if the device information of the detected input device is included in the input device model library 216, the processor 120 may create a 3D mask using the device information retrieved from the input device model library 216. In other embodiments, the processor 120 may adjust a stored reference 3D mask of the detected input device to perform 3D reconstruction.

The 3D reconstruction operation 225 generally operates to perform 3D reconstruction to create a 3D model (mesh) of the detected input device. This may include the processor 120 using the 3D mask's points as the 3D point cloud, segmenting the mask, reconstructing a surface using the mask, checking planarity, or removing artifacts. If the input device model library 216 includes the device information of the detected input device, the processor 120 may simply adjust the reference model of the detected input device (such as head pose adjustment). In other cases, the processor 120 may further refine the layout of the input device components in the reconstructed 3D model based on the reference model.

The virtual image creation operation 230 generally operates to create a 3D virtual image of the detected input device using the 3D reconstructed model. This may include the processor 120 generating a left virtual image and a right virtual image of the reconstructed 3D model using the depth map and the reference model. This may also include the processor 120 combining the stereoscopic pair of the images and generating a virtual image of the 3D reconstructed model. The matching operation 235 generally operates to overlap the virtual and physical images of the detected input device. This may include the processor 120 overlaying the 3D reconstructed model on top of the transformed images of the detected physical input device.

The connection operation 240 generally operates to detect finger gestures of the user to determine user inputs made to the physical input device. This may include the processor 120 connecting the 3D reconstructed input device with each finger gesture to identify a corresponding user input. This may also include the processor 120 making a connection between each input device component and a corresponding finger to perform finger gesture tracking, detection, and recognition. That is, as the user interacts with the detected input device using the electronic device 101, the processor 120 may detect the finger gestures and recognize the user inputs. This may further include the processor 120 performing occlusion handling and finger gesture tracking. This may additionally include the processor 120 providing the user inputs to the electronic device 101 to render final image frames for display based on the user inputs.

The final image frame rendering operation 245 generally operates to create final image frames based on the transformed image frames with the 3D reconstructed input device. Among other things, the final image frames can include virtual images of the 3D reconstructed input device overlapped with one or more transformed images of the detected physical input device, the user's fingers interacting with the combined virtual and physical input device, and executing the user input(s) on the combined virtual and physical input device.

Although FIG. 2 illustrates one example of a process 200 for physical input device extraction and 3D reconstruction, various changes may be made to FIG. 2. For example, various components or functions in FIG. 2 may be combined, further subdivided, replicated, omitted, or rearranged and additional components or functions may be added according to particular needs.

FIG. 3 illustrates an example process 300 for physical keyboard extraction and 3D reconstruction in accordance with this disclosure. For ease of explanation, the process 300 shown in FIG. 3 is described as being performed using the electronic device 101 in the network configuration 100 shown in FIG. 1. However, the process 300 shown in FIG. 3 may be performed using any other suitable device(s) and in any other suitable system(s). Moreover, the process 300 is tailored to physical extraction and 3D reconstruction of a keyboard, which is one of the most commonly used input devices. However, this is for illustrative purposes only, and the process 300 can be applied to any other suitable type of input device.

As shown in FIG. 3, the process 300 includes a data capture operation 301, a transformation operation 310, a keyboard detection operation 315, a report operation 320, a keyboard region information identification operation 325, a keyboard reconstruction operation 330, a virtual image creation operation 335, a matching operation 340, a connection operation 345 and a final image frame rendering operation 350. The data capture operation 301 generally operates to capture one or more image frames and associated data. In this example, the data capture operation 301 includes an image frame capture operation 302, a depth capture operation 303, a head pose capture operation 304, and a finger gesture capture operation 305.

The image frame capture operation 302 generally operates to capture one or more image frames of a scene. This can be the same as or similar to the image frame capture operation 202 of FIG. 2. The depth capture operation 303 generally operates to obtain depth data associated with each image frame. This can be the same as or similar to the depth capture operation 203 of FIG. 2. The head pose capture operation 304 generally operates to obtain information related to the pose of a user's head while the electronic device 101 is being used. This can be the same as or similar to the head pose capture operation 204 of FIG. 2.

The finger gesture capture operation 305 generally operates to obtain information related to the gestures of a user's fingers while the user is providing inputs to the electronic device 101 via a combined virtual and physical keyboard. This may include the processor 120 identifying the user's hand(s) in a scene and tracking the 3D position of each hand to detect finger gestures. This may also include the processor 120 applying a blob detection or deep learning-based segmentation to isolate the user's hand(s) as a mask in one or more transformed image frames. This may further include the processor 120 mapping the keypoints of the hand(s) to 3D coordinates, such as by using a warped depth map, and outputting the 3D coordinates of the hand(s) and fingers for finger gesture tracking. This may also include the processor 120 analyzing each finger's 3D trajectory to detect gestures indicative of key pressing (such as a downward motion toward a key) or key switching (such as a planar movement from one key to another). This may further include the processor 120 computing a velocity and acceleration of the user's fingertips, identifying finger gestures (such as pressing, switching, etc.), identifying pressed keys, blending virtual frames with transformed image frames, such as by using depth-based compositing and handling occlusions with a 3D mask and depth map. This may additionally include the processor 120 outputting final images showing the finger gestures on the combined keyboard and continuously tracking the finger gestures across transformed image frames to handle multiple presses and maintain interaction state.

The transformation operation 310 generally operates to apply one or more transformations to the one or more image frames in order to generate one or more transformed image frames. The transformations can be static or dynamic depending on the implementation. In this example, the transformations include an undistortion operation 311, a viewpoint matching operation 312, and a depth enhancement operation 313.

The undistortion operation 311 generally operates to correct lens distortion in the captured image frames by the one or more imaging sensors 180. This may include the processor 120 of the electronic device 101 undistorting the captured image frames using respective intrinsic parameters of the imaging sensor(s) 180 used to capture the image frames. The intrinsic parameters generally describe how each imaging sensor 180 perceives objects and can include a focal length, a principal point, and distortion coefficients. The focal length may indicate the degree of the imaging sensor's telescopic strength (such as an amount of zooming). The principal point may indicate the center of the image on which the imaging sensor's optical points are focused. The distortion coefficients may indicate an extent of lens distortions (such as image warping caused by a lens of the imaging sensor). Since the processor 120 can obtain the intrinsic parameters for each imaging sensor 180, such as through camera calibration or learning, the processor 120 can identify the extent of the lens distortions and correct for the associated image distortions, such as by moving pixels so that straight lines appear straight.

In some cases, the processor 120 may use an imaging sensor calibration and distortion model 307 to obtain the intrinsic parameters, correct lens distortion, and generate undistorted image frames. For example, the imaging sensor calibration and distortion model 307 can be stored in a model database 306 and used to calibrate the intrinsic and extrinsic parameters of the one or more imaging devices 180. The model 307 may also be used to estimate the lens distortion using the intrinsic parameters and undistort the captured image frames. In some cases, the model 307 may include a polynomial model, Fisheye model, or a deep learning model. The model database 306 may be a local or remote database or server and can include various models to assist with physical input device extraction and 3D reconstruction.

The viewpoint matching operation 312 generally operates to transform the undistorted image frames to match desired viewpoints (such as the user's eye positions) or rendering perspectives (such as from the perspective of the display(s) 160). This may include the processor 120 applying one or more transformations to compensate for things like registration and parallax errors, which may be caused by factors like differences between the positions of the imaging sensor(s) 180 and a user's eyes. That is, image frames are captured by one or more imaging sensor(s) 180 at one or more locations, but rendered images are viewed by a user's eyes that are at different locations. Thus, the processor 120 may apply the one or more transformations to transform the image frames from the viewpoints of the imaging sensors 180 to viewpoints of virtual cameras using the high-resolution dense depth maps. Since the parallax at the virtual viewpoints is corrected, the perception position and orientation of the generated 3D virtual objects are the same as the real-world objects (such as keyboards or other input devices), preparing them for real-world keyboard processing and virtual keyboard view generation.

In some cases, the processor 120 may use an imaging sensor perspective correction model 308 to perform perspective correction on the undistorted image frames. For example, the imaging sensor perspective correction model 308 can be stored in the model database 306 and used to adjust for viewpoint to ensure geometric and perspective accuracy. In some cases, the imaging sensor perspective correction model 308 can perform real-time computation of the user's head pose to correct for projective distortions.

The depth enhancement operation 313 generally operates to enhance the captured depth data. This may include the processor 120 performing depth densification and super-resolution to generate high-resolution depth maps and sparse depth points, such as by using a localization and mapping process. For example, the electronic device 101 can use simultaneous localization and mapping (SLAM) to simultaneously build a map of an environment and determine its position within that map. One result of this process can include sparse depth points, such as 3D coordinates of key features such as corners or edges detected in the scene. Since these sparse depth points may not be sufficiently dense to create a high-resolution depth map for rendering or precise XR interactions, depth densification can be used to interpolate or estimate depth values for areas between sparse depth points to create dense depth maps. This may include the processor 120 propagating depth values to neighboring pixels or optimizing to respect the sparse points (such as by using an algorithm like Markov Random Fields). Further, super-resolution can be used to increase the resolution of the dense depth maps, such as upsampling by interpolation or refining the dense depth maps.

The processor 120 may combine depth densification and super-resolution to generate dense high-solution depth maps, which can be useful for realistic rendering in VST XR applications. Additionally, the dense depth maps can be denoised. This may include the processor 120 applying spatial filtering, temporal filtering, or optimization to the dense depth maps, such as through depth warping or occlusion. Depth warping is a process of transforming the depth data to align with the undistorted and perspective-corrected image frames. Such alignment can be useful for accurate 3D registration of virtual objects in captured scenes. Hence, warped high-resolution depth maps may correspond pixel-for-pixel with undistorted perspective-corrected image frames and thus enable accurate 3D registration of virtual objects.

The keyboard detection operation 315 generally operates to obtain the one or more transformed image frames and detect a physical keyboard within the one or more transformed image frames. This may include the processor 120 performing depth-based keyboard detection and extraction with the transformed image frames and the warped depth maps corresponding to undistorted and perspective-corrected image frames. In this example, the keyboard detection operation 315 includes a blob detection operation 316, a keyboard region segmentation and extraction operation 317, and a determination operation 318.

The blob detection operation 316 generally operates to identify a binary large object (a blob). In computer vision, a blob refers to a contiguous region of pixels in an image frame that are grouped together based on certain shared properties, such as intensity, color, or texture. A blob can represent keypoints or interest points, such as corners. A blob can also represent an object or one or more parts of an object, such as a keyboard or fingers, in a scene. In some cases, to detect a blob, the processor 120 may apply one or more image processing techniques on the transformed image frames. For example, the processor 120 may apply an image thresholding technique with different thresholds to create binary images by comparing pixel intensities to a threshold value. For instance, pixels above the threshold value can be set to one value (such as white) and the pixels below the threshold value can be set to another value (such as black) or vice versa to generate a binary image in which regions of interest are separated from the background. Using multiple thresholds, the image thresholding at various intensity levels can be applied to capture different objects or features. Multiple binary images can also be generated with different thresholds to detect blobs with varying intensities.

The keyboard region segmentation and extraction operation 317 generally operates to segment and extract a keyboard region using a detected blob. This may include the processor 120 using the image thresholding to isolate regions with specific intensity characteristics and defining boundaries. Depth data can be used to improve segmentation by incorporating 3D information. Upon segmentation, the processor 120 may extract the segmented keyboard.

The determination operation 318 generally operates to determine whether the extracted blob includes a keyboard. This may include the processor 120 checking a geometry of the blob to determine a shape of the blob. This may also include the processor 120 performing a visual check of the blob to identify features of interest. This may further include the processor 120 applying a depth or contextual check to classify the blob as an object, such as a keyboard. The report operation 320 generally operates to report the detection result of the blob. This may include the processor 120 reporting to the electronic device 101 that no physical real-world keyboard is detected in the current transformed image frame.

The keyboard region information identification operation 325 generally operates to identify information of the detected keyboard. In this example, the keyboard region information identification operation 325 includes a keypoint identification operation 326, a keyboard type identification operation 327 and a keyboard region refine operation 328. The keypoint identification operation 326 generally operates to identify keypoints in the extracted keyboard region. This may include the processor 120 detecting and extracting keypoints of the detected keyboard, such as with a depth-based keypoint detection approach. A depth-based keypoint detection approach incorporates depth information to improve keypoint detection. This may also include the processor 120 selecting keypoints based on geometric properties, such as by using a warped high-resolution depth map. Keypoints represent distinctive repeatable points on an object or a feature in an image that are robust to changes in scale, rotation, lighting, or viewpoint. Keypoints can, for example, include corners, edges, specific keys, unique patterns, or a key or block layout that can be reliably detected and matched across images. To identify keypoints, the processor 120 may use one or more algorithms (such as a Scale-Invariant Feature Transform or a Speeded-up Robust Features and Harris Corner Detector) to analyze pixel intensity gradients and locate the keypoints.

The keyboard type identification operation 327 generally operates to identify the type of a detected keyboard using the extracted keypoints. This may include the processor 120 identifying one or more specific keys and a layout to determine the type of the detected keyboard. For example, a WINDOWS button can be used to identify a keyboard for a WINDOWS-based computer, or the layout can be used to identify the maker, year, and model of the detected keyboard. The keyboard type identification operation 327 may also include the processor 120 searching the keyboard model library 309 to determine the type of the detected keyboard using the keypoints and the layout of the detected keyboard. In some cases, the keyboard model library 309 can include keyboards added by manufacturers at manufacturing or keyboards added by the user upon keyboard detection during the use of the electronic device 101. As such, the keyboard model library 309 may be continuously updated throughout the usage of the electronic device 101.

If the keyboard model library 309 includes the same type of the detected keyboard, the processor 120 can retrieve a stored 3D-reconstructed keyboard model of the same keyboard type from the keyboard model library 309 and use the stored 3D reconstructed virtual keyboard for that model (possibly with minor adjustments such as head pose adjustment). If the keyboard model library 309 does not include the same type of keyboard model, the processor 120 may perform 3D reconstruction of the detected keyboard on-the-fly. In some cases, even if the keyboard model library 309 includes a 3D-reconstructed keyboard model of the same keyboard type, the processor 120 may still perform 3D reconstruction of the detected keyboard.

The keyboard region refine operation 328 generally operates to refine the identified keyboard region and key layout. This may include the processor 120 refining the keyboard region and the layout using the identified keypoints and type to improve the 3D reconstruction of the detected keyboard. For example, the processor 120 may apply depth data to improve segmentation by incorporating 3D information (such as grouping pixels with similar depths). The processor 120 may also refine the segmented keyboard region to improve boundaries and edges in the keyboard region by using, such as Canny edge detection.

The keyboard reconstruction operation 330 generally operates to reconstruct a 3D representation (a 3D keyboard model) of the detected keyboard. In this example, the keyboard reconstruction operation 330 includes a mask generation operation 331 and a 3D reconstruction operation 332. The mask generation operation 331 generally operates to create a 3D keyboard mask using the identified keyboard information. This can be the same as or similar to the 3D mask generation operation 220 of FIG. 2.

The 3D reconstruction operation 332 generally operates to perform 3D reconstruction to create a 3D keyboard (mesh) of the detected keyboard. This may include the processor 120 using the 3D mask's points as the 3D point cloud, segmenting the mask reconstructing a surface using the 3D keyboard mask, checking planarity, or removing artifacts. The processor 120 may also refine the layout of the keys in the reconstructed 3D keyboard, such as based on a reference keyboard for the detected keyboard stored in the keyboard model library 309. For example, the processor 120 may remove outliers, define the keys using the keypoints, and apply a reconstruction algorithm (such as a Poisson conversion). The 3D-reconstructed keyboard can include clean surfaces for the body of the keyboard, keys, and edges with normal textures and state (pose) aligned using extrinsic parameters.

The virtual image creation operation 335 generally operates to create a virtual image of the 3D-reconstructed keyboard. This may include the processor 120 generating a left virtual image and a right virtual image of the reconstructed 3D keyboard model using the depth map and the reference keyboard model. This may also include the processor 120 combining the stereoscopic pair of the images and generating the virtual image of the 3D-reconstructed keyboard. The matching operation 340 generally operates to overlap the virtual and physical images of the detected keyboard. This may include the processor 120 overlaying the virtual images of the 3D reconstructed model on top of the transformed images of the detected physical keyboard.

The connection operation 345 generally operates to detect finger gestures, determine user inputs on the detected keyboard, and provide the user inputs to the electronic device 101 to render final image frames for presentation on the display(s) 160. This may include the processor 120 overlapping and matching the 3D virtual keyboard and the detected keyboard. This may also include the processor 120 connecting the 3D-reconstructed keyboard with the corresponding finger gestures to identify the user inputs. The processor 120 may make a connection between each key or keyboard block and a corresponding finger to perform finger gesture tracking, detection, and recognition. As the user interacts with the detected keyboard, the processor 120 may detect the finger gestures and recognize the text or commands and provide the recognized text or commands. In some cases, this may allow final image frames of the XR scene to include the user interactions (typing), which may be displayed in real-time on the display(s) 160 of the electronic device 101.

The connection operation 345 may further include the processor 120 performing occlusion handling and finger gesture tracking. For example, a portion of the 3D-reconstructed keyboard (the 3D virtual keyboard) can be occluded by the user's hand(s). In such cases, the occlusion handling may include the processor 120 segmenting objects in the one or more captured images, tracking and predicting each occluded portion's positions, identifying the occluded portions, and adjusting the rendering such that the user's hand(s) appear in front of the occluded portions. This may also include the processor 120 reconstructing each of the occluded portions, such as via inferring based on visible parts and/or the reference keyboard.

In some cases, an XR scene can be initialized with a 3D-reconstructed keyboard, keyboard layout and keys, transformed image frame(s), and depth map(s). Using the depth map(s), the processor 120 can detect the user's hand(s) within the one or more transformed image frames and map the user's fingertips to 3D and handle occlusion, such as with temporal tracking or stereo triangulation, to generate 3D coordinates of the user's fingertip(s). Using the 3D coordinates, the processor 120 can compute velocity and acceleration for finger gestures and identify the finger gestures, such as typing text or commands, based on corresponding angles associated with the user's hand(s) and the depth map(s). The processor 120 can continuously render and display images of the XR scene including the user inputs (such as finger gestures on the 3D virtual keyboard overlapped on the physical keyboard) as well as execution of the user inputs in real-time. For example, if the user presses an escape key, the finger gesture can be tracked in 3D (possibly despite a hand occlusion) and identified as a press using depth data and other information, such as temporal, angular, and proximity data between the fingers and keys.

The final image frame rendering operation 350 generally operates to create final image frames including the transformed image frames with the 3D-reconstructed keyboard. This may be the same as or similar to the final image frame rendering operation 245 of FIG. 2. Among other things, the final image frames can include the virtual images of the 3D-reconstructed keyboard overlayed and matched with the detected physical keyboard and the user's fingers interacting with the combined virtual and physical keyboard, and the user inputs can be identified and executed or otherwise used.

Although FIG. 3 illustrates one example of a process 300 for physical keyboard extraction and 3D reconstruction, various changes may be made to FIG. 3. For example, various components or functions in FIG. 3 may be combined, further subdivided, replicated, omitted, or rearranged and additional components or functions may be added according to particular needs.

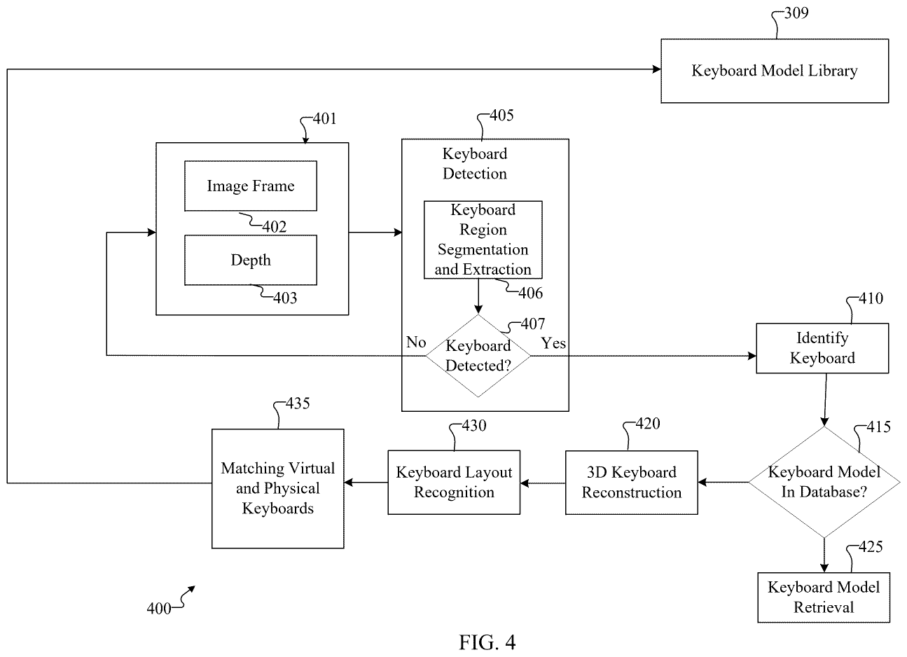

FIG. 4 illustrates an example technique 400 for online creation of a 3D-reconstructed keyboard using a keyboard model library 309 in accordance with this disclosure. For ease of explanation, the technique 400 shown in FIG. 4 is described as being performed using the electronic device 101 in the network configuration 100 shown in FIG. 1. However, the technique 400 shown in FIG. 4 may be performed using any other suitable device(s) and in any other suitable system(s).

As shown in FIG. 4, the technique 400 includes a data capture operation 401, a keyboard detection operation 405, a keyboard identification operation 410, a search operation 415, a keyboard reconstruction operation 420, a retrieval operation 425, a keyboard layout and key recognition operation 430, and a matching operation 435. The data capture operation 401 generally operates to capture one or more image frames and associated data. In this example, the data capture operation 401 includes an image frame capture operation 402 and depth capture operation 403. The image frame capture operation 402 generally operates to capture one or more image frame (such as a left image frame and a right image frame) of a scene and may be the same as or similar to the image frame capture operation 302 of FIG. 3. The depth capture operation 403 generally operates to capture depth to generate depth maps and may be the same as or similar to the depth capture operation 303 of FIG. 3.

The keyboard detection operation 405 generally operates to detect and extract a keyboard region from one or more transformed image frame. In this example, the keyboard detection operation 405 includes a keyboard region segmentation and extraction operation 406 and a determination operation 407. The keyboard region segmentation and extraction operation 406 generally operates to segment and extract keyboard region from a blob having similar properties (such as contrast) and may be the same as or similar to the keyboard region segmentation and extraction operation 317 of FIG. 3. The determination operation 407 generally operates to determine whether a keyboard is detected in the segmented keyboard region and may be the same as or similar to the determination operation 318 of FIG. 3.

If a keyboard is detected, the keyboard identification operation 410 generally operates to identify the type of the detected keyboard. This may include the processor 120 identifying one or more specific keys and the type of the detected keyboard using the one or more specific keys and refining the keyboard region. This may be the same as or similar to the keyboard region information identification operation 325 of FIG. 3. If a keyboard is not detected, the technique 400 can revert to the data capture operation 401.

The search operation 415 generally operates to search for the detected keyboard in a keyboard model library 309. This may include the processor 120 checking whether the keyboard model library 309 includes the type of the detected keyboard. In checking for the detected keyboard, the processor 120 may compare the layout, type, and model name or number of the detected keyboard with those of the stored keyboards. In some cases, the keyboard model library 309 may include keyboards with identifying keypoints, key patterns, and corresponding 3D-reconstructed keyboards.

If the keyboard model library 309 includes the same keyboard type as that of the detected keyboard, the retrieval operation 425 generally operates to retrieve the 3D-reconstructed keyboard (the reference keyboard) of the same keyboard type. This may include the processor 120 adjusting the retrieved reference keyboard to account for the current head pose. If the keyboard model library 309 does not include the same keyboard type, the keyboard reconstruction operation 420 generally operates to perform 3D reconstruction with the one or more transformed image frames and the depth map to generate a 3D-reconstructed keyboard.

The keyboard layout and key recognition operation 430 generally operates to recognize the layout and key of the detected keyboard. This may include the processor 120 building a keyboard layout and recognizing keypoints and keys in the with the one or more transformed image frames. The matching operation 435 generally operates to overlap and match the 3D-reconstructed keyboard model with the detected keyboard. This may include the processor 120 combining virtual images (left and right) of the 3D-reconstructed keyboard to generate one or more virtual images of the 3D-reconstructed keyboard. This may also include the processor 120 refining the 3D-reconstructed keyboard with the real keyboard parameters including size dimensions, keys, shape, and specifications. This may be the same as or similar to the matching operation 340 of FIG. 3.

Although FIG. 4 illustrates one example of a technique 400 for online creation of a 3D-reconstructed keyboard using a keyboard model library 309, various changes may be made to FIG. 4. For example, various components or functions in FIG. 4 may be combined, further subdivided, replicated, omitted, or rearranged and additional components or functions may be added according to particular needs.

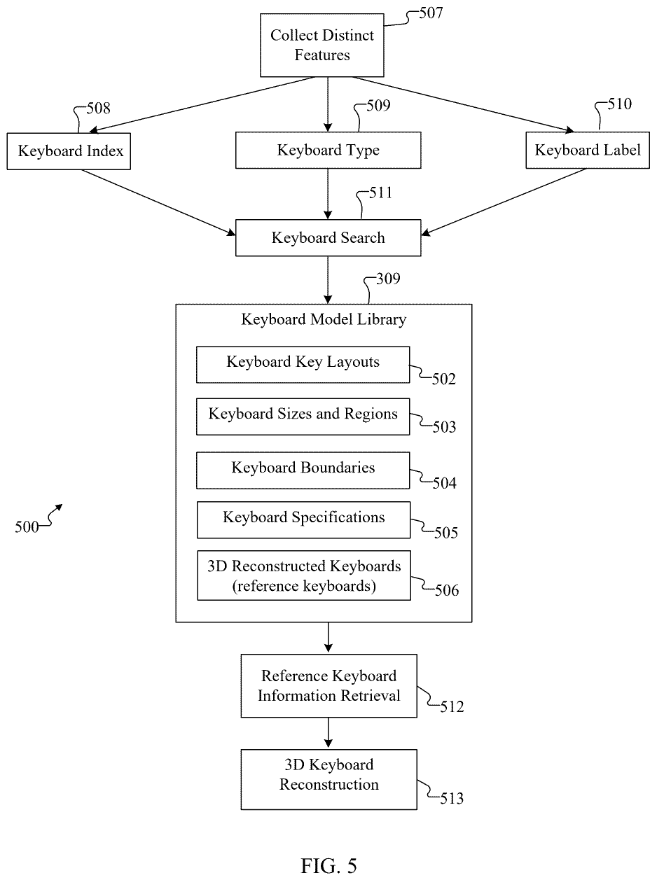

FIG. 5 illustrates an example pipeline 500 for offline creation of a 3D-reconstructed keyboard using a keyboard model library 309 in accordance with this disclosure. For ease of explanation, the pipeline 500 shown in FIG. 5 is described as being performed using the electronic device 101 in the network configuration 100 shown in FIG. 1. However, the pipeline 500 shown in FIG. 5 may be performed using any other suitable device(s) and in any other suitable system(s).

As shown in FIG. 5, the pipeline 500 includes a keyboard model library 309, a feature identification function 507, a keyboard index determination function 508, a keyboard type determination function 509, a keyboard label determination function 510, a keyboard search function 511, a reference information retrieval function 512, and a 3D reconstruction function 513. The keyboard model library 309 generally operates to store device information of one or more stored keyboard models. In this example, the keyboard model library 309 stores keyboard key layouts 502, keyboard sizes and regions 503, keyboard boundaries 504, keyboard specifications 505, and 3D-reconstructed keyboards (reference keyboards) 506. The processor 120 may access the keyboard model library 309 to determine the type of a detected keyboard and retrieve relevant keyboard information for 3D reconstruction of the detected keyboard.

The feature identification function 507 generally operates to collect distinct features unique to the detected keyboard that can be used to identify the detected keyboard. This may include the processor 120 identifying special keys (such as an option key, a command key, or a WINDOWS key), size, brand, color, a number of keys, a number of sections, logs, or numbers of sections that may represent the detected keyboard. The keyboard index determination function 508 generally operates to identify a keyboard index of the stored keyboards. This may include the processor 120 using the distinct features collected to determine the keyboard index of the detected keyboard.

The keyboard type determination function 509 generally operates to identify the type of the detected keyboard. This may include the processor 120 using the distinct features and/or index to identify the type of the detected keyboard. The keyboard label determination function 510 generally operates to identify the label of the detected keyboard. This may include the processor 120 determining the keyboard label of the detected keyboard. The keyboard search function 511 generally operates to use the identified keyboard information, such as the identified features, index, type, and/or label of the detected keyboard, to search for a reference keyboard model having the same or substantially same keyboard information in the keyboard model library 309. This may include the processor 120 accessing the keyboard model library 309 to identify a reference keyboard for the detected keyboard.

The reference information retrieval function 512 generally operates to retrieve reference keyboard information of the identified reference keyboard. This may include the processor 120 accessing the keyboard model library 309 to obtain relevant keyboard information of the identified reference keyboard from the keyboard model library 309. For example, the processor 120 can obtain one or more of the reference keyboard key layout, keyboard size and regions, keyboard boundary, keyboard specification, and the reference keyboard. The reference keyboard may include one or more sub-models of the 3D keys of the detected keyboard. The 3D reconstruction function 513 generally operates to adjust the reference 3D-reconstructed keyboard model with the current user head pose for rendering. This may include the processor 120 obtaining the user's head pose data and modifying the reference 3D-reconstructed keyboard model to fit the current head pose and corresponding predicted head pose at display.

Although FIG. 5 illustrates one example of a pipeline 500 of offline creation of a 3D-reconstructed keyboard using a keyboard model library 309, various changes may be made to FIG. 5. For example, various components or functions in FIG. 5 may be combined, further subdivided, replicated, omitted, or rearranged and additional components or functions may be added according to particular needs. In addition, the pipeline 500 can be adjusted to create libraries for different types of input devices, such as mice, electronic pens, car wheels, etc. and generate 3D reconstructed models of different types of input devices.

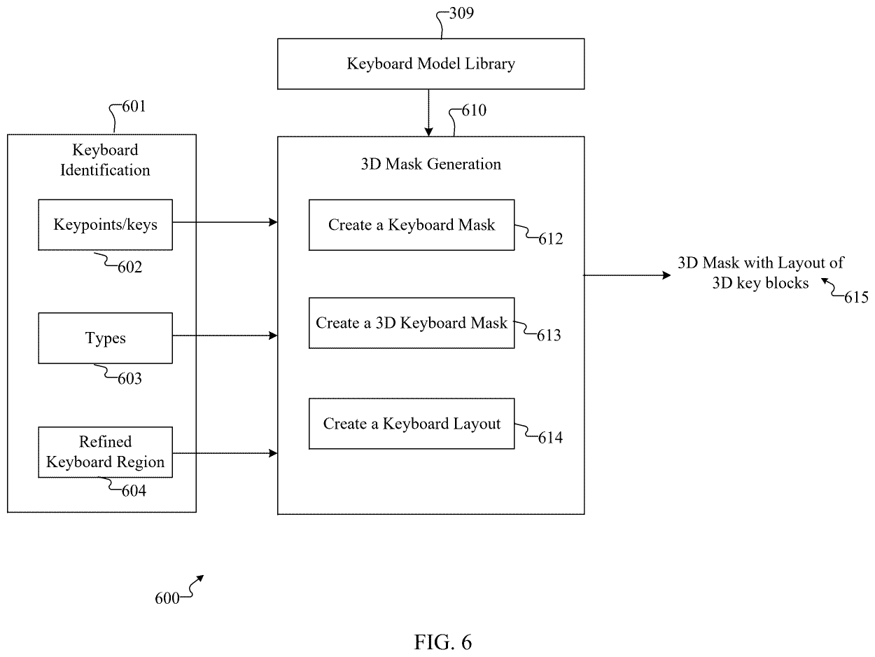

FIG. 6 illustrates an example technique 600 for 3D mask generation of a keyboard in accordance with this disclosure. For ease of explanation, the technique 600 shown in FIG. 6 is described as being performed using the electronic device 101 in the network configuration 100 shown in FIG. 1. However, the technique 600 shown in FIG. 6 may be performed using any other suitable device(s) and in any other suitable system(s).

As shown in FIG. 6, the technique 600 includes a keyboard identification operation 601 and a 3D mask generation operation 610. The keyboard identification operation 601 generally operates to identify information of the detected keyboard, such as keypoints and specific keys 602, a type 603, and refined keyboard region and boundaries 604. The keyboard identification operation 601 may be the same as or similar to the keyboard region information identification operation 325 of FIG. 3.

The 3D mask generation operation 610 generally operates to generate a 3D keyboard mask using the identified keyboard information and the keyboard model library 309. In this example, the 3D mask generation operation 610 includes a keyboard mask creation operation 612, a 3D keyboard mask creation operation 613, and a keyboard layout creation operation 614. The keyboard mask creation operation 612 generally operates to create a keyboard mask using the identified keyboard information. This may include the processor 120 generating a 2D keyboard mask using the identified keypoints, keyboard region, and boundaries.

The 3D keyboard mask creation operation 613 generally operates to create a 3D keyboard mask using the 2D keyboard mask. This may include the processor 120 reconstructing a 3D mask for the detected keyboard using the refined keyboard region and boundary and the dense high-resolution depth map. The keyboard layout creation operation 614 generally operates to create a key and/or keyboard layout on the 3D mask. This may include the processor 120 creating 3D blocks of the keys on the 3D mask. The final 3D keyboard mask 615, thus, includes the 3D key blocks that can be helpful in performing the 3D keyboard reconstruction.

Although FIG. 6 illustrates one example of a technique 600 for 3D mask generation of a keyboard, various changes may be made to FIG. 6. For example, various components or functions in FIG. 6 may be combined, further subdivided, replicated, omitted, or rearranged and additional components or functions may be added according to particular needs. In addition, the technique 600 can be adjusted to generate 3D masks of different types of input devices, such as mice, electronic pens, car wheels, etc.

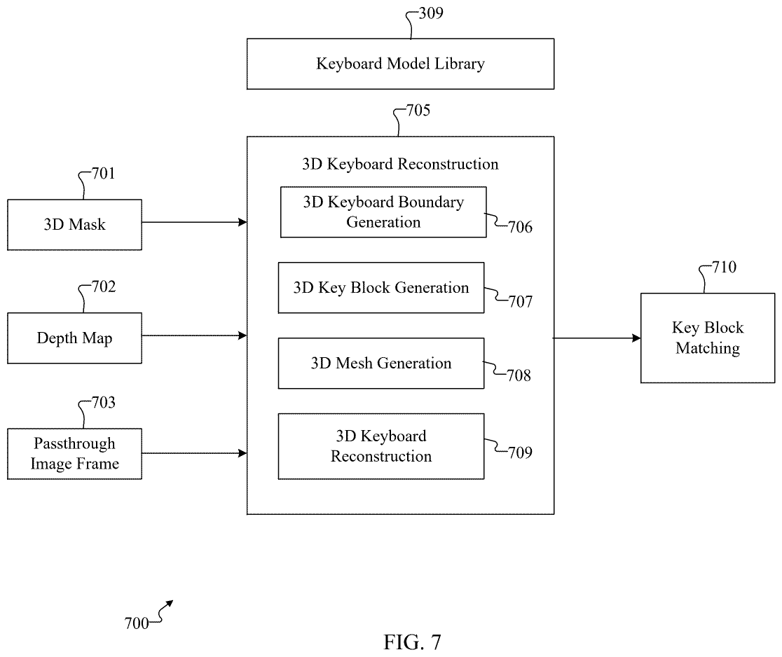

FIG. 7 illustrates an example technique 700 for 3D keyboard reconstruction in accordance with this disclosure. For ease of explanation, the technique 700 shown in FIG. 7 is described as being performed using the electronic device 101 in the network configuration 100 shown in FIG. 1. However, the technique 700 shown in FIG. 7 may be performed using any other suitable device(s) and in any other suitable system(s).

As shown in FIG. 7, the technique 700 includes a 3D keyboard reconstruction operation 705 and a key block matching operation 710. The 3D keyboard reconstruction operation 705 generally operates to perform 3D reconstruction of a detected keyboard in one or more transformed image frames. In this example, the 3D keyboard reconstruction operation 705 includes a keyboard boundary generation operation 706, a keyboard block generation operation 707, a 3D mesh generation operation 708, and a 3D reconstruction operation 709.

The keyboard boundary generation operation 706 generally operates to create a keyboard boundary. This may include the processor 120 obtaining the 3D mask 701, a dense depth map 702, and one or more passthrough transformed image frames 703 to generate the 3D contour and boundary of the detected keyboard using the 3D mask 701. The keyboard block generation operation 707 generally operates to generate 3D key blocks of the detected keyboard. This may include the processor creating the 3D key blocks and a 3D key block layout using the 3D mask 701 and the dense depth map 702.

The 3D mesh generation operation 708 generally operates to generate a 3D mesh of the detected keyboard. This may include the processor 120 generating a 3D surface of the 3D keyboard using the 3D keyboard boundary, the 3D key blocks, and the 3D mask 701. This may also include the processor 120 performing 3D reconstruction of the keyboard using the 3D key block layout to generate a 3D-reconstructed keyboard.

The key block matching operation 710 generally operates to match the 3D key blocks with the physical key blocks. This may include the processor 120 overlapping the 3D reconstructed key blocks with the passthrough transformed images of the physical key blocks using the 3D-reconstructed keyboard to recognize each of the keys of the keyboard. This may also include the processor 120 retrieving and using a reference keyboard (stored in the keyboard model library 309) for the detected keyboard. Thus, the 3D-reconstructed keyboard can be obtained with key blocks recognized.

Although FIG. 7 illustrates one example of a technique 700 for 3D keyboard reconstruction, various changes may be made to FIG. 7. For example, various components or functions in FIG. 7 may be combined, further subdivided, replicated, omitted, or rearranged and additional components or functions may be added according to particular needs. In addition, the technique can be adjusted to perform 3D reconstruction of different types of input devices, such as mice, electronic pens, car wheels, etc.

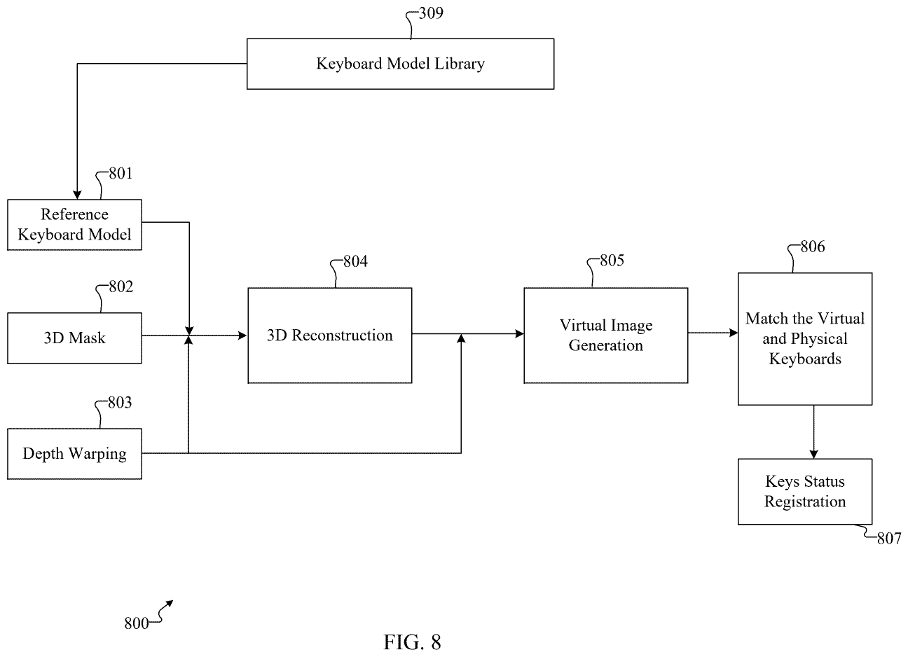

FIG. 8 illustrates an example technique 800 for matching virtual and physical images of a keyboard in accordance with this disclosure. For ease of explanation, the technique 800 shown in FIG. 8 is described as being performed using the electronic device 101 in the network configuration 100 shown in FIG. 1. However, the technique 800 shown in FIG. 8 may be performed using any other suitable device(s) and in any other suitable system(s).

As shown in FIG. 8, the technique 800 includes a reference keyboard model extraction operation 801, a 3D mask generation operation 802, a depth warping operation 803, a 3D reconstruction operation 804, a 3D virtual image generation operation 805, a matching operation 806, and a keys status registration operation 807. The reference keyboard model extraction operation 801 generally operates to extract a reference keyboard model (a reference keyboard) from a keyboard model library 309. This may include the processor 120 identifying the type of the physical keyboard captured and searching for the same type in the keyboard model library 309. The 3D mask generation operation 802 generally operates to create 3D mask of the detected keyboard. This may include the processor 120 extracting keypoints and a keyboard boundary extracted from the captured one or more image frames. This may be the same as or similar to the 3D mask generation operation 331 of FIG. 3 or the 3D mask generation operation 610 of FIG. 6.

The depth warping operation 803 generally operates to warp depths (dense depth maps) to correspond to the passthrough-transformed images of the captured keyboard. This may include the processor 120 warping the depths in accordance with undistorted and perspective-corrected image frames. The 3D reconstruction operation 804 generally operates to perform 3D reconstruction of the captured keyboard using the 3D mask. This may include the processor 120 generating a 3D layout of the keys and key blocks within the 3D mask using the dense depth map(s) and the reference keyboard model. This may be the same as or similar to the keyboard reconstruction operation 330 of FIG. 3.

The 3D virtual image generation operation 805 generally operates to generate a 3D virtual image of the 3D-reconstructed keyboard. This may include the processor 120 combining a left 3D virtual image viewed from the left imaging sensor viewpoint and a right 3D virtual image viewed from the right imaging sensor viewpoint to generate a final image frame for rendering. This may be the same as or similar to the virtual image creation operation 335 of FIG. 3. The matching operation 806 generally operates to overlap the 3D virtual image and the passthrough-transformed image of the captured keyboard such that the corresponding keys match. This may be the same as or similar to the matching operation 340 of FIG. 3.

The keys status registration operation 807 generally operates to register the status of the physical keys in real-time. This may include the processor 120 registering the key status to make the 3D key blocks ready for finger gesture change based on user input on physical keys. This may also include the one or more sensors 180 tracking finger gestures (user inputs) made on the physical keys of the keyboard and detecting figure gesture changes associated with the keys to recognize the key statuses (such as the scroll up key being pressed). This may further include the processor 120 providing the finger gestures/user inputs for execution of the user inputs.

Since a keyboard image may represent only a fraction of the image frames captured, the keyboard image processing and depth reconstruction may require little or minimum computation resources of the electronic device 101 during use. Thus, the 3D keyboard reconstruction can be performed quickly. The availability of reference keyboard models in the keyboard model library 309 further increases the efficiency of the 3D keyboard reconstruction. Since the 3D virtual image of the 3D-reconstructed keyboard overlaps the real-world keyboard, when the user types the real-world keyboard, the position of the finger typing gestures effectively connects the keys at the virtual 3D keyboard, and the key statuses can be used by the electronic device 101.

Although FIG. 8 illustrates one example of a technique 800 for matching virtual and physical images of a keyboard, various changes may be made to FIG. 8. For example, various components or functions in FIG. 8 may be combined, further subdivided, replicated, omitted, or rearranged and additional components or functions may be added according to particular needs. In addition, the technique can be adjusted to match virtual and physical images of different types of input devices such as mice, electronic pens, car wheels, etc.

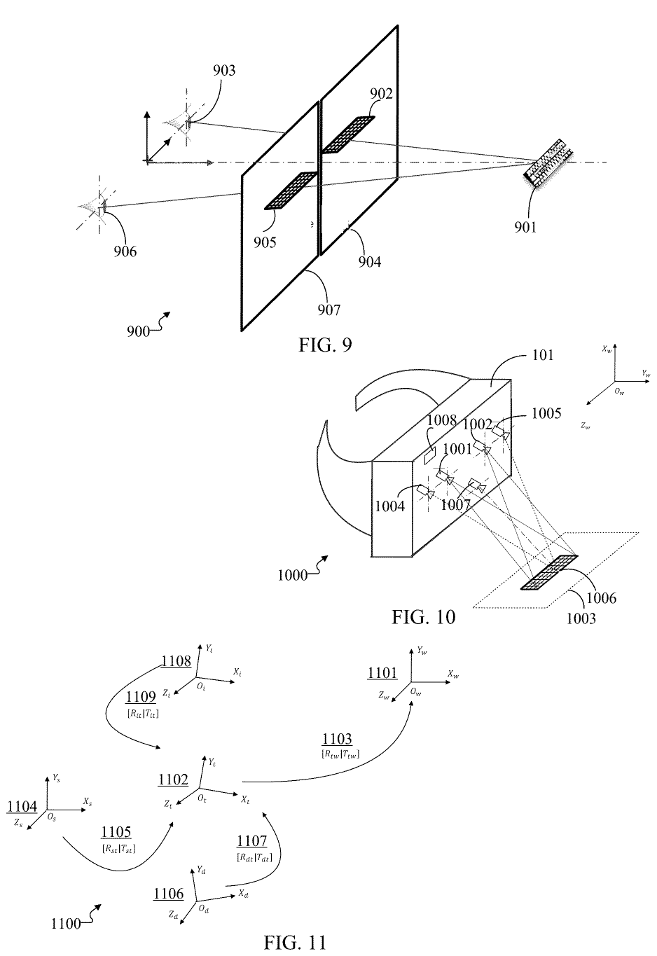

FIG. 9 illustrates an example diagram 900 of 3D keyboard reconstruction in accordance with this disclosure. For ease of explanation, the 3D keyboard reconstruction shown in FIG. 9 is described as being performed using the electronic device 101 in the network configuration 100 shown in FIG. 1. However, the 3D keyboard reconstruction shown in FIG. 9 may be performed using any other suitable device(s) and in any other suitable system(s).

As illustrated in FIG. 9, the electronic device 101 may capture one or more image frames of a scene including a physical keyboard. A left virtual image 902 of the reconstructed 3D keyboard 901 is rendered to a left display panel 904. A right virtual image 905 of the reconstructed 3D keyboard 901 is rendered to a right display panel 907. The user can see the reconstructed 3D keyboard 901 at the left viewpoint 903 and the right viewpoint 906. That is, the left virtual image 902 and the right virtual image 905 may be combined to create a stereoscopic 3D effect, allowing the user to perceive the reconstructed 3D keyboard 901 in three dimensions. The user can interact with the virtual image of the 3D-reconstructed keyboard 901, which is aligned with the physical keyboard, allowing for a seamless experience of using the real-world keyboard.

Although FIG. 9 illustrates one example of a diagram 900 of 3D keyboard reconstruction, various changes may be made to FIG. 9. For example, different types of input devices, such as mice, electronic pens, car wheels, etc., can be 3D reconstructed.

FIG. 10 illustrates an example technique 1000 for keyboard tracking and extraction in accordance with this disclosure. For ease of explanation, the technique 1000 shown in FIG. 10 is described as being performed using the electronic device 101 in the network configuration 100 shown in FIG. 1. However, the technique 1000 shown in FIG. 10 may be performed using any other suitable device(s) and in any other suitable system(s).

As illustrated in FIG. 10, the electronic device 101 may include a pair of see-through cameras 1001-1002, a pair of tracking stereo cameras 1004-1005, a depth sensor 1007, and a position sensor (such as an IMU) 1008 to enable passthrough XR, where a real-world view is captured and augmented with digital content. The see-through cameras 1001-1002 may represent two imaging sensors 180 of the electronic device 101 and can capture one or more image frames of a scene 1003. In some cases, the see-through cameras 1001-1002 can be positioned to mimic human eyes using a world coordinate system (X_{w}, Y_{w}, Z_{w}) with an origin Ow.

The tracking stereo cameras 1004-1005 may also represent two imaging sensors 180 and can be used to detect a keyboard 1006 (if one exists) in the scene 1003. Upon detection, the tracking stereo cameras 1004-1005 may track the keyboard pose in each image frame. In some cases, the one or more image frames may include see-through high-resolution color images. The high-resolution color images may be used for keyboard mask generation (as illustrated in the mask generation operation 331 of FIGS. 3) and 3D reconstruction (as illustrated in the 3D reconstruction operation 332 of FIG. 3) of the keyboard 1006.

A depth sensor 1007 (such as a ToF depth sensor) may capture a depth map of the scene 1003. The depth map may be applied for viewpoint matching (as illustrated in the viewpoint matching operation 312 of FIGS. 3) and 3D reconstruction of the keyboard 1006. A position sensor (such as an IMU) 1008 may detect and track the head pose of the electronic device 101. Thus, the electronic device 101 may utilize the data from the sensors 1001-1002, 1004-1005, 1007, and 1008 to detect and track the keyboard 1006 in the real world, enabling the overlay of virtual elements or interactions.

Although FIG. 10 illustrates one example of a technique 1000 for keyboard tracking and extraction, various changes may be made to FIG. 10. For example, various components or functions in FIG. 10 may be combined, further subdivided, replicated, omitted, or rearranged and additional components or functions may be added according to particular needs. In addition, the technique can be adjusted to track and extract different types of input devices, such as mice, electronic pens, car wheels, etc.

FIG. 11 illustrates example coordinate systems 1100 for keyboard tracking and 3D reconstruction in accordance with this disclosure. For ease of explanation, the example coordinate systems shown in FIG. 11 are described as being used by the electronic device 101 in the network configuration 100 shown in FIG. 1. However, the example coordinate systems 1100 shown in FIG. 11 may be used by any other suitable device(s) and in any other suitable system(s).

As shown in FIG. 11, example coordinate systems 1100 may include one or more of the following: a world coordinate system O_{w}X_{w}Y_{w}Z_{w} 1101; a pose tracking coordinate system OₜXₜYₜZₜ 1102 with transformation to the world coordinate system [R_{tw}|T_{tw}] 1103; a see-through camera coordinate system OₛXₛYₛZₛ 1104 with transformation to the pose tracking coordinate system [Rₛₜ|Tₛₜ] 1105; a depth sensor coordinate system O_{d}X_{d}Y_{d}Z_{d} 1106 with transformation to the pose tracking coordinate system [R_{dt}|T_{dt}] 1107; and an IMU coordinate system OᵢXᵢYᵢZᵢ 1108 with transformation to the pose tracking coordinate system [Rᵢₜ|Tᵢₜ] 1109. The coordinate systems 1100 may be rigidly connected. Thus, for example, when the camera pose in the pose tracking coordinate system 1102 is obtained, the poses in other coordinate systems can be computed.

Although FIG. 11 illustrates examples of coordinate systems 1100 for keyboard tracking and 3D reconstruction, various changes may be made to FIG. 11. For example, different coordinate systems and transformations may be used. In addition, the coordinate systems and transformations can be adjusted to track different types of input devices, such as mice, electronic pens, car wheels, etc.

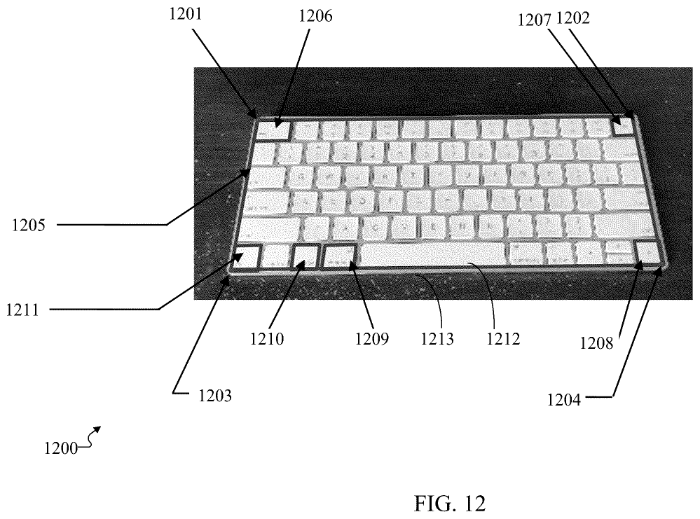

FIG. 12 illustrates an example technique 1200 for keyboard feature detection in accordance with this disclosure. For ease of explanation, the technique 1200 shown in FIG. 12 is described as being performed using the electronic device 101 in the network configuration 100 shown in FIG. 1. However, the technique 1200 shown in FIG. 12 may be performed using any other suitable device(s) and in any other suitable system(s).

As illustrated in FIG. 12, the features to be detected may include keypoints 1201-1204, a keyboard boundary 1205, and keys 1206-1211 of a keyboard 1212. Keypoints 1201-1204 may include the top left, top right, bottom right, and bottom left points of the keyboard 1212. The keypoints 1201-1204 may serve as specific reference points on the keyboard boundary 1205 to help identify the orientation and position of the keyboard 1212 in 3D space. A keyboard region 1213 can be defined with the keypoints 1201-1204. Keypoint feature detection approaches, such as the Scale-Invariant Feature Transform (SIFT) or Speeded-Up Robust Features (SURF), can be used to detect and extract the keypoints 1201-1204.

The keyboard boundary 1205 can be determined by the keypoints 1201-1204 or detected with an object boundary detection algorithm (such as Canny edge detection algorithm). The keyboard boundary 1205 may be used to determine the keyboard region 1213 and a keyboard 2D mask. Detection of key keys 1206-1211 of the keyboard 1212 may also be performed. With the key keys 1206-1211, the type of the keyboard 1212 may be recognized. For example, MAC and WINDOWS keyboards may include special keys, and these special keys and correspondence positions can be used to determine the type of the keyboard 1212 and extract more information from a keyboard model library (such as the keyboard model library 309 of FIG. 3).

Although FIG. 12 illustrates one example of a technique 1200 for keyboard feature detection, various changes may be made to FIG. 12. For example, different computer vision algorithms (such as Oriented FAST and Rotated BRIEF, KAZE and AKAZE, etc.) may be utilized to detect keypoints. In addition, the technique 1200 can be adjusted to detect features of different types of input devices, such as mice, electronic pens, car wheels, etc.

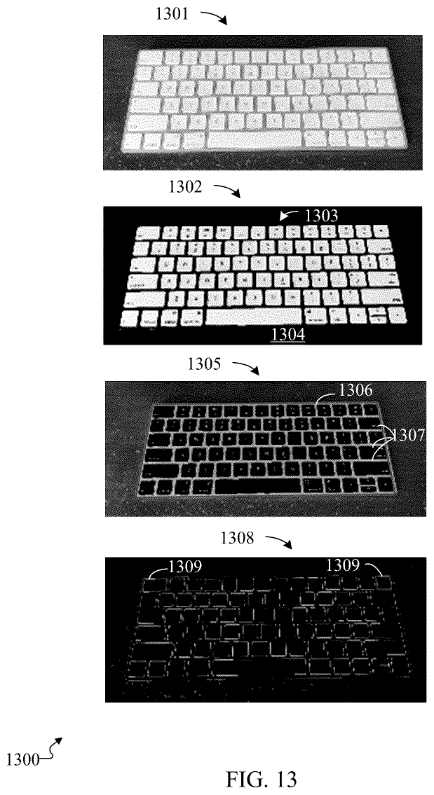

FIG. 13 illustrates an example process 1300 for keyboard detection in accordance with this disclosure. For ease of explanation, the process 1300 shown in FIG. 13 is described as being performed using the electronic device 101 in the network configuration 100 shown in FIG. 1. However, the process 1300 shown in FIG. 13 may be performed using any other suitable device(s) and in any other suitable system(s).

As illustrated in FIG. 13, one or more images 1301 of a real-world keyboard are obtained. This may include one or more imaging sensors 180 of the electronic device 101 capturing the one or more images 1301. The one or more imaging sensors 180 may be a pair of see-through cameras 1001-1002 of FIG. 10 and may capture the one or more images 1301 based on the see-through camera coordinate system 1104 of FIG. 11.

The one or more images 1301 may undergo image segmentation to generate one or more segmented images 1302. This may include the processor 120 separating the scene foreground from the scene background, such as by using an imaging thresholding technique. As such, the processor 120 may apply the image thresholding technique to the one or more images 1301 to generate one or more segmented images 1302 by separating a keyboard image (the foreground) 1303 from the background 1304.

The image thresholding may be further applied to the one or more segmented images 1302 to obtain a keyboard boundary 1306. The effectiveness of the image thresholding technique can depend on choosing a correct threshold value or range. This may include the processor 120 adjusting one or more thresholding parameters (such as intensity levels) or performing adaptive thresholding using multiple threshold values to account for lighting variations, shadows, or noise in the one or more segmented images 1302. By applying the correct thresholding parameters, the outer edge (boundary 1306) of the keyboard can be distinctly isolated from the background 1304, making it easier to identify and track the shape of the keyboard. Further, the individual keys on the keyboard can be isolated as distinct boxes (such as rectangular regions) 1307 when the correct thresholding parameters are selected.

The keyboard boundary 1306 and key blocks boundaries can be extracted from the one or more boundary-isolated images 1305. This may include the processor 120 using an edge and contour detection algorithm (such as a Canny edge detection algorithm) to detect and extract the boundary 1306 of the keyboard and the boundaries 1309 of the key blocks from one or more edge-detected images 1308. A Canny edge detection algorithm can be used to detect the edges in the one or more boundary-isolated images 1305 by reducing noise, computing gradients to identify rapid intensity changes, applying double thresholding, and performing edge-tracking by hysteresis.

In some embodiments, keypoint feature detection can be performed using keypoint feature extraction algorithms, such as SIFT or SURF, to extract important or useful keypoints (such as keypoints 1201-1204 of FIG. 12) of the four conners of the keyboard. With the detected contours 1306, 1307, 1309 and the keypoints of the keyboard from the one or more images 1301, the region of the keyboard can be defined, such as by using a rectangular area. A keyboard mask can also be created with the defined region of the keyboard.

Although FIG. 13 illustrates one example of a process 1300 of keyboard detection, various changes may be made to FIG. 13. For example, different edge detection algorithms (such as Roberts cross operator, zero-crossing edge detection, etc.) may be utilized to detect edges and contours of the one or more images capturing a keyboard. In addition, different types of input devices, such as mice, electronic pens, car wheels, etc., can be detected.

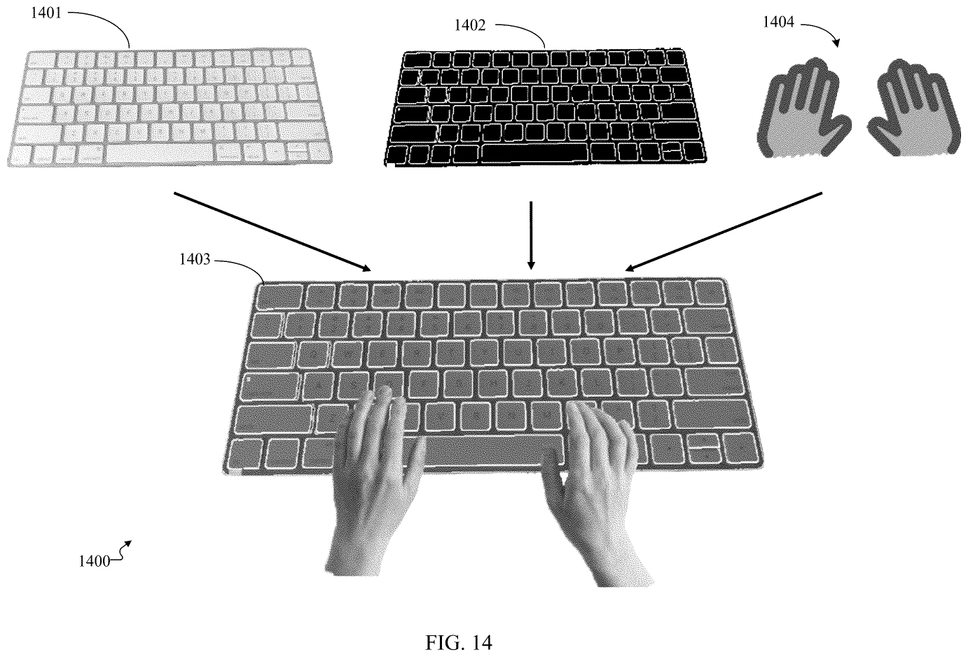

FIG. 14 illustrates an example process 1400 of matching a virtual and physical keyboards based on 3D keyboard reconstruction in accordance with this disclosure. For ease of explanation, the process 1400 shown in FIG. 14 is described as being performed using the electronic device 101 in the network configuration 100 shown in FIG. 1. However, the process 1400 shown in FIG. 14 may be performed using any other suitable device(s) and in any other suitable system(s).

As shown in FIG. 14, an image of a physical keyboard 1401 can be detected from a scene captured by one or more imaging sensors 180 of the electronic device 101. This may be performed in the same or similar manner as the keyboard detection operation 315 of FIG. 3. From the image of the physical keyboard 1401, a 3D keyboard model 1402 may be reconstructed. This may be performed in the same or similar manner as the keyboard reconstruction operation 330 of FIG. 3. A virtual image of the reconstructed 3D-reconstructed keyboard model 1402 may be created and overlayed on top of the physical keyboard 1401 to generate a combined virtual and physical keyboard 1403. This may be performed in the same or similar manner as the virtual image creation operation 335 of FIG. 3.

One or more images of the user's hands 1404 may be captured by the one or more imaging sensors 180 of the electronic device 101. The one or more images of the user's hands 1404 may be overlapped on top of the 3D-reconstructed keyboard model 1402. This may be performed in the same or similar manner as the connection operation 345 of FIG. 3. Upon the overlapping, the user's fingers may click on keys on both the physical keyboard 1401 and the 3D keyboard model 1402 simultaneously.

In this way, the combined virtual and physical keyboard 1403 can provide an optimized user experience that other virtual keyboards cannot provide. For example, projected keyboard images on a surface (such as on top of a desk) only allow the user to merely click the projected keyboard image, thereby failing to provide an experience of using a real-life keyboard. The 3D-reconstructed keyboard model 1402, on the other hand, allows the user to physically type on a real-world keyboard and enter user input as if the physical keyboard is connected to the electronic device 101, thereby improving the user's experience. Moreover, the user's operation on the overlapped 3D-reconstructed keyboard model 1402 and the physical keyboard 1401 may provide the user with the same accurate rate of input as with a real-life keyboard. In contrast, projected keyboard images may suffer from occlusions and other relevant issues, jeopardizing the accuracy rate of the user inputs (such as due to the use of an infrared camera as a finger gesture tracking device).

Although FIG. 14 illustrates one example of a process 1400 of matching a virtual and physical keyboards based on 3D keyboard reconstruction, various changes may be made to FIG. 14. For example, the virtual and physical input devices of different types, such as mice, electronic pens, car wheels, etc., can be matched based on 3D input device reconstruction.

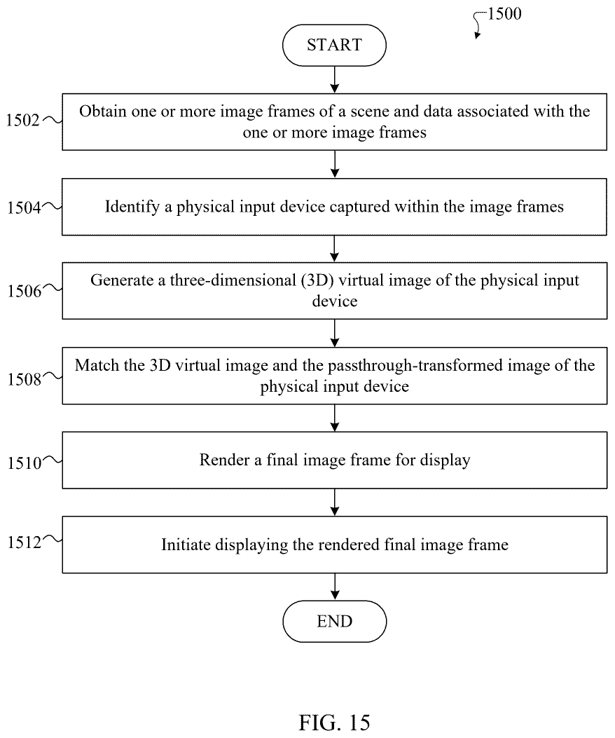

FIG. 15 illustrates an example method 1500 for physical input device extraction and 3D reconstruction in accordance with this disclosure. For ease of explanation, the method 1500 shown in FIG. 15 is described as being performed using the electronic device 101 in the network configuration 100 shown in FIG. 1, where the electronic device 101 may implement the process 300 shown in FIG. 3. However, the method 1500 may be performed using any other suitable device(s) and in any other suitable system(s), and the method 1500 may be implemented using any other suitable process(es) or architecture(s) designed in accordance with this disclosure.

As shown in FIG. 15, at step 1502, one or more image frames of a scene and data associated with the one or more image frames are obtained. This may include, for example, the processor 120 of the electronic device 101 obtaining one or more image frames and data associated with the one or more image frames using a plurality of sensors 180 of the electronic device 101. The data associated with the one or more image frames can include depth data.

At step 1504, a physical input device captured within the image frames is identified. This may include, for example, the processor 120 of the electronic device 101 performing passthrough transformations on the image frames to generate one or more transformed image frames. This may also include the processor 120 segmenting an input device region within the one or more transformed image frames to generate a segmented input device region. This may further include the processor 120 identifying keypoints in the segmented input device region using the depth data. The keypoints may include corners, edges, patterns, and input device components. This may also include the processor 120 identifying an input device type using the keypoints and/or an input device model library including different types of physical input devices and corresponding 3D reconstructed input device models. This may further include the processor 120 refining the input device region using the keypoints and the input device type to generate a refined input device region. In addition, this may include the processor 120 extracting the refined input device region from the one or more transformed image frames to generate an extracted input device region.

At step 1506, a 3D virtual image of the physical input device is generated. This may include, for example, the processor 120 of the electronic device 101 creating a 3D input device mask using a dense depth map of the extracted input device region. This may also include the processor 120 creating a 2D input device mask using the extracted input device region and a boundary of the extracted input device region. This may further include the processor 120 creating the 3D input device mask with the 2D input device mask and the dense depth map and creating an input device component layout on the 3D input device mask. This may also include the processor 120 performing 3D reconstruction on the 3D input device mask using the keypoints and a boundary of the extracted input device region to generate a 3D reconstructed input device model. This may further include the processor 120 generating input device component blocks and an input device component layout using the 3D input device mask and the dense depth map and generating a 3D mesh of the physical input device using the input device contour and boundary and the input device component blocks. In addition, this may include the processor 120 generating the 3D reconstructed input device model using the input device component layout and the 3D mesh and generating one or more virtual views of the 3D reconstructed input device model.

At step 1508, the 3D virtual image and the passthrough-transformed image of the physical input device are matched. This may include the processor 120 overlapping the 3D virtual image with the passthrough-transformed image of the physical input device. This may also include the processor 120 connecting input device components and a finger gesture sensor of the plurality of the sensors to detect and recognize a finger gesture and a corresponding user input. In some cases, the finger gesture sensor may apply an occlusion culling.

At step 1510, the final image frame is rendered based on the matched 3D virtual image and the passthrough transformed image of the physical input device and, at step 1512, display of the rendered final image frame is initiated. This may include, for example, the processor 120 of the electronic device 101 rendering the final image frame based on the matched 3D virtual image and the transformed image of the physical input device and displaying the rendered image frame on at least one display 160 of the electronic device 101. In some embodiments, visual enhancement on the matched images may be applied before or during the rendering. In some cases, the visual enhancement may include noise reduction and image enhancement.

Although FIG. 15 illustrates one example of a method 1500 for physical input device extraction and 3D reconstruction, various changes may be made to FIG. 15. For example, while shown as a series of steps, various steps in FIG. 12 may overlap, occur in parallel, occur in a different order, or occur any number of times (including zero times).

It should be noted that the functions shown in or described with respect to FIGS. 2 through 15 can be implemented in an electronic device 101, 102, 104, server 106, or other device(s) in any suitable manner. For example, in some embodiments, at least some of the functions shown in or described with respect to FIGS. 2 through 15 can be implemented or supported using one or more software applications or other software instructions that are executed by the processor 120 of the electronic device 101, 102, 104, server 106, or other device(s). In other embodiments, at least some of the functions shown in or described with respect to FIGS. 2 through 15 can be implemented or supported using dedicated hardware components. In general, the functions shown in or described with respect to FIGS. 2 through 15 can be performed using any suitable hardware or any suitable combination of hardware and software/firmware instructions. Also, the functions shown in or described with respect to FIGS. 2 through 15 can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
obtaining, using a plurality of sensors of an electronic device, one or more image frames of a scene and data associated with the image frames, the data comprising depth data;
identifying, using at least one processing device of the electronic device, a physical input device captured within the image frames;
generating, using the at least one processing device, a three-dimensional (3D) virtual image of the physical input device; and
matching, using the at least one processing device, the 3D virtual image and a passthrough-transformed image of the physical input device to generate a final image frame for rendering.

2. The method of claim 1, wherein identifying the physical input device comprises:
performing passthrough transformations on the image frames to generate one or more transformed image frames;
segmenting an input device region within the one or more transformed image frames to generate a segmented input device region;
identifying keypoints in the segmented input device region using the depth data, the keypoints including corners, edges, patterns, and input device components;
identifying an input device type using the keypoints and/or an input device model library including different types of physical input devices and corresponding 3D reconstructed input device models;
refining the input device region using the keypoints and the input device type to generate a refined input device region; and
extracting the refined input device region from the one or more transformed image frames to generate an extracted input device region.

3. The method of claim 2, wherein generating the 3D virtual image comprises:
creating a 3D input device mask using a dense depth map of the extracted input device region;
performing 3D reconstruction on the 3D input device mask using the keypoints and a boundary of the extracted input device region to generate a 3D reconstructed input device model; and
generating one or more virtual views of the 3D reconstructed input device model.

4. The method of claim 3, wherein creating the 3D input device mask comprises:
creating a two-dimensional (2D) input device mask using the extracted input device region and a boundary of the extracted input device region; and
creating the 3D input device mask with the 2D input device mask and the dense depth map; and
further comprising creating an input device component layout on the 3D input device mask.

5. The method of claim 3, wherein performing the 3D reconstruction comprises:
generating an input device contour and boundary using the 3D input device mask;
generating input device component blocks and an input device component layout using the 3D input device mask and the dense depth map;
generating a 3D mesh of the physical input device using the input device contour and boundary and the input device component blocks; and
generating the 3D reconstructed input device model using the input device component layout and the 3D mesh.

6. The method of claim 1, wherein matching the 3D virtual image and the passthrough-transformed image of the physical input device comprises:
overlapping the 3D virtual image with the passthrough-transformed image of the physical input device; and
connecting input device components and a finger gesture sensor of the plurality of the sensors to detect and recognize a finger gesture and a corresponding user input, the finger gesture sensor applying an occlusion culling.

7. The method of claim 1, further comprising:
creating an input device model library including different types of physical input devices and information associated with each type, the information comprising an input device component layout, an input device size, an input device region, an input device boundary, input device specifications, and a corresponding 3D reconstructed input device model; and
updating the input device model library with one or more new types of physical input devices upon detection, information associated with the one or more new types, and one or more corresponding 3D reconstructed input device models.

8. The method of claim 1, further comprising:
tracking, using the plurality of sensors, finger gestures made on the physical input device;
detecting the finger gestures to recognize a user input; and
providing the user input to the electronic device for execution of the user input.

9. An apparatus comprising:
a plurality of sensors configured to obtain one or more image frames of a scene and data associated with the image frames, the data comprising depth data; and
at least one processing device configured to:
identify a physical input device captured within the image frames;
generate a three-dimensional (3D) virtual image of the physical input device; and
match the 3D virtual image and a passthrough-transformed image of the physical input device to generate a final image frame for rendering.

10. The apparatus of claim 9, wherein, to identify the physical input device, the at least one processing device is configured to:
perform passthrough transformations on the image frames to generate one or more transformed image frames;
segment an input device region within the one or more transformed image frames to generate a segmented input device region;
identify keypoints in the segmented input device region using the depth data, the keypoints including corners, edges, patterns, and input device components;
identify an input device type using the keypoints and/or an input device model library including different types of physical input devices and corresponding 3D reconstructed input device models;
refine the input device region using the keypoints and the input device type to generate a refined input device region; and
extract the refined input device region from the one or more transformed image frames to generate an extracted input device region.

11. The apparatus of claim 10, wherein, to generate the 3D virtual image, the at least one processing device is configured to:
create a 3D input device mask using a dense depth map of the extracted input device region;
perform 3D reconstruction on the 3D input device mask using the keypoints and a boundary of the extracted input device region to generate a 3D reconstructed input device model; and
generate one or more virtual views of the 3D reconstructed input device model.

12. The apparatus of claim 11, wherein, to generate the 3D virtual image, the at least one processing device is configured to:
create a two-dimensional (2D) input device mask using the extracted input device region and a boundary of the extracted input device region; and
create the 3D input device mask with the 2D input device mask and the dense depth map; and
wherein the at least one processing device is further configured to create an input device component layout on the 3D input device mask.

13. The apparatus of claim 11, wherein, to perform the 3D reconstruction, the at least one processing device is configured to:
generate an input device contour and boundary using the 3D input device mask;
generate input device component blocks and an input device component layout using the 3D input device mask and the dense depth map;
generate a 3D mesh of the physical input device using the input device contour and boundary and the input device component blocks; and
generate the 3D reconstructed input device model using the input device component layout and the 3D mesh.

14. The apparatus of claim 9, wherein, to match the 3D virtual image and the passthrough-transformed image of the physical input device, the at least one processing device is configured to:
overlap the 3D virtual image with the passthrough-transformed image of the physical input device; and
connect input device components and a finger gesture sensor of the plurality of the sensors to detect and recognize a finger gesture and a corresponding user input, the finger gesture sensor applying an occlusion culling.

15. The apparatus of claim 9, wherein the at least one processing device is further configured to:
create an input device model library including different types of physical input devices and information associated with each type, the information comprising an input device component layout, an input device size, an input device region, an input device boundary, input device specifications, and a corresponding 3D reconstructed input device model; and
update the input device model library with one or more new types of physical input devices upon detection, information associated with the one or more new types, and one or more corresponding 3D reconstructed input device models.

16. A non-transitory machine readable medium containing instructions that when executed cause at least one processor of an electronic device to:
obtain one or more image frames of a scene and data associated with the image frames, the data comprising depth data;
identify a physical input device captured within the image frames;
generate a three-dimensional (3D) virtual image of the physical input device; and
match the 3D virtual image and a passthrough-transformed image of the physical input device to generate a final image frame for rendering.

17. The non-transitory machine readable medium of claim 16, wherein the instructions that when executed cause the at least one processor to identify the physical input device comprise instructions that when executed cause the at least one processor to:
perform passthrough transformations on the image frames to generate one or more transformed image frames;
segment an input device region within the one or more transformed image frames to generate a segmented input device region;
identify keypoints in the segmented input device region using the depth data, the keypoints including corners, edges, patterns, and input device components;
identify an input device type using the keypoints and/or an input device model library including different types of physical input devices and corresponding 3D reconstructed input device models;
refine the input device region using the keypoints and the input device type to generate a refined input device region; and
extract the refined input device region from the one or more transformed image frames to generate an extracted input device region.

18. The non-transitory machine readable medium of claim 17, wherein the instructions that when executed cause the at least one processor to generate the 3D virtual image comprise instructions that when executed cause the at least one processor to:
create a two-dimensional (2D) input device mask using the extracted input device region and a boundary of the extracted input device region; and
create the 3D input device mask with the 2D input device mask and the dense depth map; and
wherein the non-transitory machine readable medium further contains instructions that when executed cause the at least one processor to create an input device component layout on the 3D input device mask.

19. The non-transitory machine readable medium of claim 17, wherein the attentional mask has a shape comprising one of a rectangle, a circle, or an ellipse based on the element of the user focus and the focal distance.

20. The non-transitory machine readable medium of claim 16, wherein the instructions that when executed cause the at least one processor to perform the 3D reconstruction comprise instructions that when executed cause the at least one processor to:
generate an input device contour and boundary using the 3D input device mask;
generate input device component blocks and an input device component layout using the 3D input device mask and the dense depth map;
generate a 3D mesh of the physical input device using the input device contour and boundary and the input device component blocks; and
generate the 3D reconstructed input device model using the input device component layout and the 3D mesh.
